(19) United States
(12) Patent Application Publication
(10) Pub. No.: US 2008/0112011 A1
(43) Pub. Date: May 15, 2008

(54) OUTPUT PROCESSING APPARATUS AND DATA STRUCTURE FOR EXECUTING ITS PROCESSING

(75) Inventors: Akihiko INOUE, Fukuoka (JP); Takaaki MATSUDA, Fukuoka (JP); Kiyotaka YAMAMOTO, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/937,707

(22) Filed: Nov. 9, 2007

(30) Foreign Application Priority Data
Nov. 14, 2006 (JP) 2006-307452

(51) Int. Cl. G06K 1/00

(52) U.S. Cl. 358/1.17

(57) ABSTRACT

An output processing apparatus comprises a first storage that stores image data in a predetermined block unit, a second storage that stores a head address of each of the image data stored in the block units, and a controller that reads, from the first storage, the same line of the image data of the plural continuous blocks on a line-by-line basis based on the head address stored in the second storage, and outputs the plural lines of the readout image data to a recorder as one line of continuous image data.

### BACKGROUND

The present invention relates to an output processing apparatus for controlling an output for recording in the case of making recording of N-in-one printing (printing for laying out N pages in one page) etc. by a digital composite machine etc., and a data structure for performing its processing.

A digital composite machine having functions of a copying machine, a fax machine, a printer, etc. has become widespread in recent years. Such a digital composite machine has an input-output function by a scanner or a printer, a function of connection to a network or a communication line, a function of image processing with respect to image data, etc. Then, this image processing function includes, for example, scale-down processing for changing a resolution of inputted image data, or rotation processing for changing a direction of an image. Then, recently, high-speed processing is desired and also a digital composite machine capable of performing a concurrent operation of sending a fax while doing printing is desired.

In such a digital composite machine, a CPU first makes setting of image processing when processing for N-in-one printing is started. The set contents include, for example, a size of paper or layout of N-in-one inputted from an operation panel. After these contents are set, image data inputted from a scanner, a fax machine, a computer, etc. is transmitted from memory in which this data is temporarily stored to an image processing part and image processing is performed. Since the processing is processing of N-in-one printing, N pages are laid out in one page to form the one page, and the one page in which image processing is performed by this layout is outputted for printing.

Therefore, in image processing in the conventional digital composite machine, its processing was performed in a page unit and memory was reserved in the page unit and image data was processed by being expanded in the memory in the page unit. Therefore, in N-in-one printing in which image data of N pages was laid out in one page and was outputted, N pages of memory and memory for processing, that is, at least (N+1) pages or more of memory was required. As a result of this, while a size of the memory increased and its use efficiency decreased, a CPU performs all the processing, so that a processing speed decreased and, for example, when the concurrent operation etc. were performed, the processing became slow. FIG. 15 is an explanatory diagram conceptually showing a method of processing at the time of doing conventional four-in-one printing.

Hence, an image processing apparatus comprising an image memory in which data of the same line for image data of two pages or more transmitted from a decoder is stored in each region, a DMAC for transmitting image data of plural pages from the decoder to the image memory by alternately repeating processing for transmitting one line of data to the region using a specified address as the head every each page on which a head address TA is set, the processing having processing performed using the head address TA as the first specified address and processing for adding a skip size SS including one line of data size of other page stored in the region to an address of the back end of data stored in the region thereby and specifying the next specified address, and a recording part for recording an image of the image data stored in the image memory on one sheet of paper has been proposed (see JP-A-2005-348046).

However, also in the image processing apparatus of JP-A-2005-348046, it is necessary to expand data of the same line of N pages in the image memory and the image data decoded and processed by the decoder is transmitted to the image memory by the DMAC. But, N pages of data must be expanded in the image memory as one page of image data and the image data expanded in this image memory must again be printed by being outputted to the recording part by the CPU, the DMAC, etc. Therefore, this art processes the same line in a line unit, but is similar to the conventional art in that the image data is expanded in the image memory in a page unit and data processing is performed using the image memory. In addition to JP-A-2005-348046, other N-in-one printers have been proposed conventionally as such an art (see JP-A-6-183095).

In addition, an apparatus in which since it is necessary to easily manage image processing without imposing a high load on a CPU, image data of a page unit is divided into plural region image data (tiles) and a header in which image processing information is described is added to image data of a tile unit and packet data is generated and the generated packet data is transmitted between each of the image processing function parts through a crossbar switch and in each of the image processing parts, image processing of the region image data is performed based on the image processing information described in the header and packet data obtained by adding a header in which the image processing information is rewritten to image data after the processing is generated and outputted has been proposed (see JP-A-10-293741).

When the image processing apparatus of (JP-A-2005-348046) is compared with the conventional image processing apparatus for reserving memory in a page unit and processing image data in the page unit, there is a possibility that memory used in N-in-one printing becomes small since it is a line unit. However, in order to generate image data for printing, it was necessary to join data of each line between pages and expand the data in the image memory, and memory for at least expansion was required. Then, a problem was left in the case of performing a concurrent operation while doing high-speed printing, or doing high-speed printing in order to perform this processing. This similarly applies to the printer of JP-A-6-183095, basically.

Also, the image processing apparatus of JP-A-10-293741 performs image processing by dividing image data in a tile unit and adding a header and separating the data every function such as a resolution conversion, rotation function, a color space conversion function or a binarization function. However, it is necessary to reconfigure an image of the tile unit and data reconfigured by plural tiles at this time is image data of each page unit, and is not data in which N pages are laid out in one page in a state of exceeding a page like N-in-one.

### SUMMARY

Therefore, an object of the invention is to provide an output processing apparatus capable of making N-in-one recording at high speed without expanding data in which data of N pages is laid out in one page in memory, and a data structure for executing its processing.

An output processing apparatus of the invention comprises a first storage that stores image data in a predetermined block unit, a second storage that stores a head address of each of the image data stored in the block units, and a controller that reads, from the first storage, the same line of the image data of the plural continuous blocks on a line-by-line basis based on the head address stored in the second storage, and outputs the plural lines of the readout image data to a recorder as one line of continuous image data.

### BRIEF DESCRIPTION OF THE DRAWINGS

FIG. 1 is the whole configuration diagram of a digital composite machine in which an output processing apparatus in a first embodiment of the invention is disposed.

FIG. 2 is a block diagram showing processing of image data of the output processing apparatus in the first embodiment of the invention.

FIG. 3 is a block configuration diagram of the output processing apparatus in the first embodiment of the invention.

FIG. 4A is an explanatory diagram of four-in-one readout in the first embodiment of the invention and FIG. 4B is an explanatory diagram of a data structure in the first embodiment of the invention.

FIG. 5 is an explanatory diagram conceptually showing a method of processing at the time of doing four-in-one printing of the output processing apparatus in the first embodiment of the invention.

FIG. 6A is an explanatory diagram of two-in-one and FIG. 6B is an explanatory diagram of four-in-one and FIG. 6C is an explanatory diagram of eight-in-one.

FIG. 7 is a block configuration diagram of a printing output processing part of the output processing apparatus in the first embodiment of the invention.

FIG. 8 is a main explanatory diagram for image formation of a printing device part.

FIG. 9 is a sequence chart of the output processing apparatus in the first embodiment of the invention.

FIG. 10 is a flowchart of the case of performing a two-in-one layout.

FIG. 11 is a flowchart of the case of laying out the top column in the case of performing a four-in-one layout.

FIG. 12 is a flowchart of the case of laying out the bottom column in the case of performing a four-in-one layout.

FIG. 13 is a diagram of relation between print data and a memory configuration at the time of printing data read by an output processing apparatus in a second embodiment of the invention.

FIG. 14 is a diagram of relation between print data and read data of the output processing apparatus in the second embodiment of the invention.

FIG. 15 is an explanatory diagram conceptually showing a method of processing at the time of doing conventional four-in-one printing.

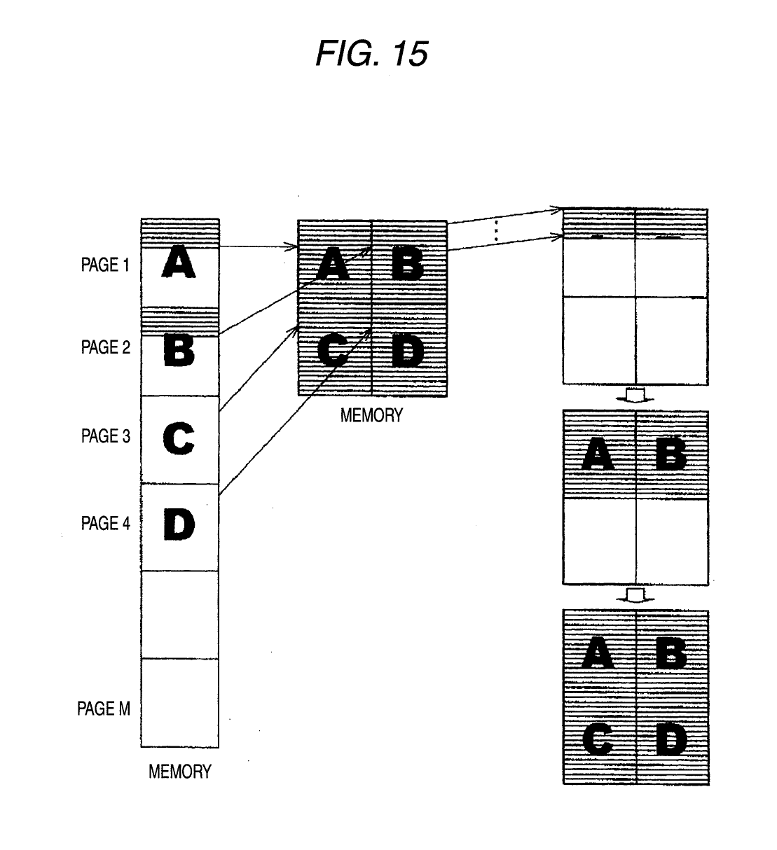

### DETAILED DESCRIPTION

### First Embodiment

An output processing apparatus in a first embodiment of the invention and a data structure disposed in memory in order to execute its processing will be described below based on the drawings.

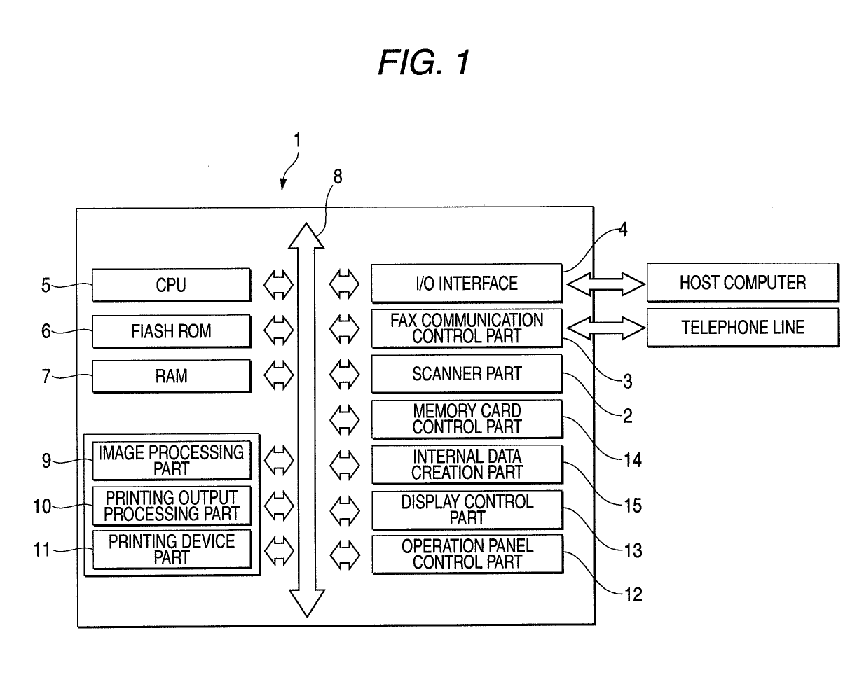

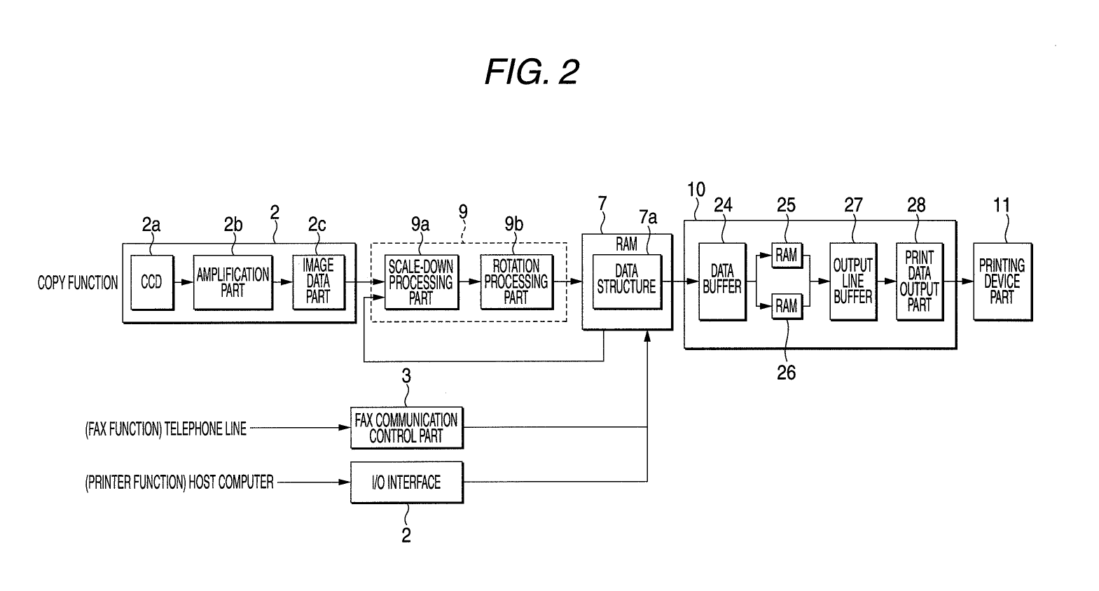

FIG. 1 is the whole configuration diagram of a digital composite machine in which an output processing apparatus in a first embodiment of the invention is disposed, and FIG. 2 is a block diagram showing processing of image data of the output processing apparatus in the first embodiment of the invention.

The first embodiment of the invention will be described below with reference to the drawings. In FIG. 1, the output processing apparatus in the first embodiment is an output processing apparatus in the case of a printing output processing apparatus or a recording output processing apparatus of a digital composite machine. In FIG. 1, numeral 1 is a digital composite machine combining functions of a copying machine, a fax machine, a printer, etc. Numeral 2 is a scanner part for reading an image by a CCD etc., and numeral 3 is a fax communication control part which is connected to a telephone line or a digital line by a protocol G3, G4 and conducts communication. Then, numeral 4 is an I/O interface which is connected to a host computer by a cable etc. and transmits data or a command to a printer driver of the host computer at the time of recording an image (at the time of printing in the first embodiment). In addition, the scanner part 2 acquires image data by reading the image data and the fax machine and the host computer also acquire image data through the fax communication control part 3 and the I/O interface 4, so that all can be called input means of the image data to the digital composite machine 1.

Numeral 5 shown in FIG. 1 is a CPU for controlling a system of the digital composite machine 1, and numeral 6 is rewritable flash ROM, and numeral 7 is RAM, and numeral 8 is an internal bus. The CPU 5 reads a program from the flash ROM 6 or ROM (not shown) and executes various functions as a control part.

Then, in FIG. 1, numeral 9 is an image processing part for analyzing image data and performing scale-down processing or rotation processing, and numeral 10 is a printing output processing part capable of doing N-in-one printing at high speed using a DMA (Direct Memory Access) function as described below. In addition, recording in the invention refers to printing in the first embodiment, but further includes means for forming and recording an image. Also, numeral 11 is a printing device part (recorder of the invention) for inputting an output from the printing output processing part 10 for image formation. This printing device part 11 is a laser printer in the first embodiment and as described below, a laser diode is disposed and laser light is emitted by this laser diode and an electrified photoconductor drum is scanned and an electrostatic picture is formed on a surface and after development, this picture is transferred to record paper (record medium of the invention) and is fixed and printed.

Also, in FIG. 1, numeral 12 is an operation panel control part (instruction unit of the invention) for making various settings from an operation panel (not shown), and numeral 13 is a display control part for controlling a display (not shown) of liquid crystal etc. Then, numeral 14 is a memory card interface for attaching a memory card in which image data is stored and doing printing. Numeral 15 is an internal data generation part of software logic for storing print patterns etc. for test and generating print data based on these patterns. Image data is stored in the memory card and data can be read out on a readout request and the internal data generation part 15 also generates image data of a pattern for test printing, so that these can be called input means for inputting image data to the digital composite machine 1 in a manner similar to the scanner part 2, the fax communication control part 3 and the host computer. Then, all the apparatus capable of performing N-in-one processing of image data stored in memory (RAM) by such input means and outputting the image data to the printing device part 11 (recorder) are included in the output processing apparatus of the invention.

Subsequently, the whole flow of how to process image information captured in the digital composite machine 1 will be described based on FIG. 2. In the case of the first embodiment, the digital composite machine 1 has a copy function, a fax function, a printer function, etc., and the copy function will be first described. The scanner part 2 has a block configuration as shown in an upper column of FIG. 2. Numeral 2a is a CCD (image pickup part) for reading a manuscript, and numeral 2b is an amplification part for amplifying an analog image signal read by the CCD 2a, and numeral 2c is an image data output part for converting the image signal amplified by the amplification part 2b into a digital signal and outputting this signal as image data.

The image data outputted from this scanner part 2 is inputted to the image processing part 9. In the image processing part 9, control of scale-down processing, rotation processing, etc. is performed when instructions of a direction, a size, etc. of paper are given from an operation panel. Numeral 9a is a scale-down processing part for changing a resolution in order to scale down an image size, and numeral 9b is a rotation processing part for rotating a direction of an image 90°. The image data processed by the image processing part 9 forms a predetermined data structure 7a and is stored and data processing described below is performed by the printing output processing part 10 and the image data is outputted to the printing device part 11.

The image data etc. received by a fax machine or a host computer are once stored in the RAM 7 and when necessary, image processing can be performed by rotation or scale-down and after the processing, the image data is again stored in the RAM 7. Here, scale-down is performed by decreasing a resolution and rotation for changing a direction is performed by skipping and reading out image data. Both the scale-down and the rotation are performed in a software manner. A configuration of the image processing part 9 and a configuration of performing subsequent processing are similar to those of the case of the copy in the fax machine or the host computer.

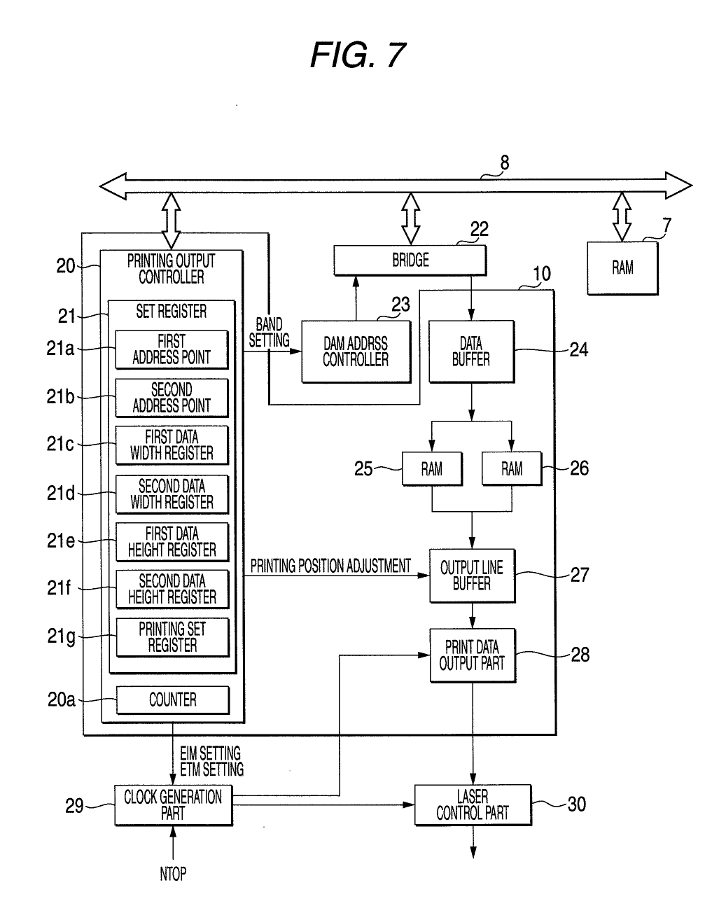

In addition, rotation of 90° (only when it is necessary to be set in a landscape direction in an N-in-one format) is performed in the case of doing N-in-one printing with respect to the image data stored in the RAM 7 and in this case, when a printing output controller 20 of FIG. 7 makes a readout request for image data from the RAM 7, an interface of the RAM 7 reads out the image data stored in the RAM 7 at a predetermined address (skip reading of a predetermined skip width) and transmits the data to the printing output processing part 10. This transmission is implemented by DMA transmission.

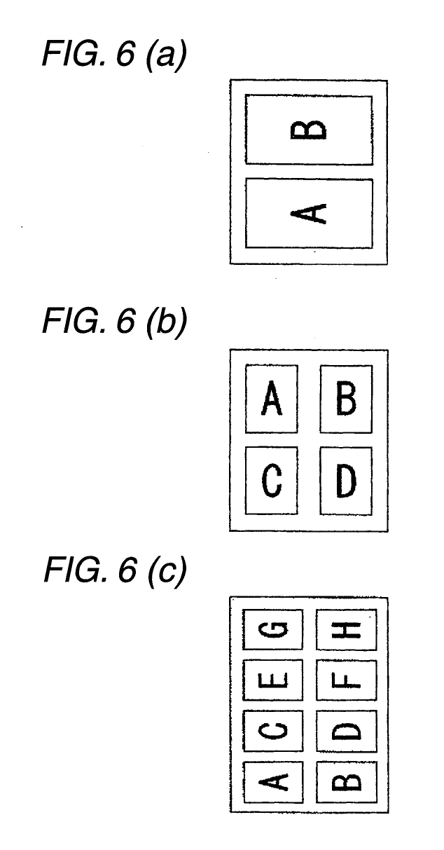

For example, in the case of two-in-one, image data of 600 dpi acquired by the CCD 2a is scaled down to 300 dpi by the image processing part 9 and is stored, and is rotated by changing an address of the origin in each block described below and skipping every one line and reading out the image data at the time of readout for being set in a landscape direction. In addition, rotation is not limited to 90° forming a left direction and other angles can also be used when the origin and a skipping width are changed. When N pages of images are laid out in one page, the images are shown in FIGS. 6A, 6B and 6C. FIG. 6A is an explanatory diagram of two-in-one, and FIG. 6B is an explanatory diagram of four-in-one, and FIG. 6C is an explanatory diagram of eight-in-one.

Sixteen-in-one can similarly be performed though its size becomes small. Then, description of laying out pages in which N is multiples of 2 in one page thus will be made below, but even for pages in which N is odd multiples (3, 5, . . . ), processing is only performed by disposing three, five, . . . , N RAMs instead of two RAMs 25, 26 (see FIG. 7) described below and the processing is basically similar. According to the output processing apparatus of the first embodiment thus, plural pages are arranged in a transverse direction of record paper and plural columns of the layouts are further arranged in a longitudinal direction and N pages as a whole can be laid out on one sheet of record paper.

In addition, the interface of the RAM 7 does not transmit data to the printing output processing part 10 after the stored image data is skipped and read at a predetermined skip width as described above, and can also output image data after the image data is rotated via the rotation processing part 9b once. N-in-one scale-down is always required in the case of making N-in-one setting, so that at a point in time of reading an image, the image can be scaled down by the scale-down processing part 9a, but it is preferable to perform N-in-one rotation at the time of printing since the rotation has a printing position adjustment or a direction of the image.

By the way, a data structure in the first embodiment in which N-in-one printing is done by address control and data processing is constructed as an aggregate of plural blocks in which image data is divided into N blocks. The image data is divided into N divided image data and is respectively held in the N blocks and is stored in the RAM 7 as an aggregate. In FIG. 2, numeral 7a shows this data structure. In the first embodiment, each of the blocks has the same size and is constructed as combination of this divided image data and a header of each of the blocks respectively arranged at the front of this divided image data. The reason why the data is divided in a block unit is because a data region of one page is smaller than that of a page unit and memory can be effectively utilized and, for example, reading of the immediately next block can be performed while printing is done in the block unit, and a speedup can be achieved.

For example, in the case of four-in-one, by the scanner part 2, page 1 and page 2 are alternately read every half height and data structures in which a header is arranged at the front of data of each half height are generated for respective pages and after this is ended, page 3 and page 4 are further alternately read every half height respectively and data structures in which a header is arranged at the front of data of each half height are generated and stored. When this block is generated in the case of a copy, readout can be performed immediately every one line and printing is done in a line unit as described below.

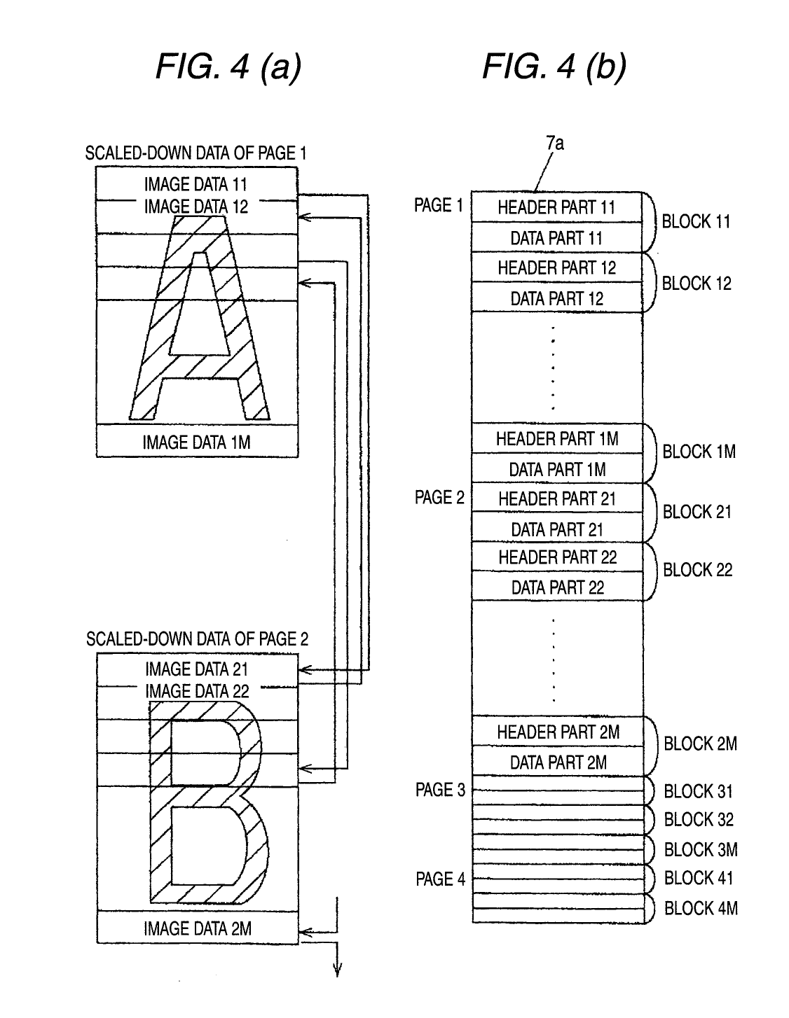

FIG. 4A shows an explanatory diagram of four-in-one readout in the first embodiment of the invention, and FIG. 4B shows an explanatory diagram of a data structure in the first embodiment of the invention.

Now, referring further to details of this data structure, a header part and a data part in which divided image data are stored are arranged in plural blocks of each page in this data structure as shown in FIG. 4B. In the case of four-in-one, one page is constructed of four blocks and data setting space (configuration space) of four pages is constructed of a total of sixteen blocks.

In image data of page 1, divided image data first read out is stored in a data part 11 and a block 1 is formed of a header part 11 and the data part 11, and divided image data next read out is stored in a data part 12 and a block 2 is formed of a header part 12 and the data part 12, and such blocks are subsequently repeated and arranged. Then, the last divided image data is stored in a data part 1M and a block M constructed of a header part 1M and the data part 1M is formed and the image data of page 1 is stored in M blocks as a whole. The divided image data of the data parts 11, 12, . . . , 1M correspond to each of the image data 11, 12, . . . , 1M shown in FIG. 4A.

Similarly, image data of page 2 is arranged at the back of a data structure of page 1 and is stored as M blocks of a block 21 constructed of a header part 21 and a data part 21, a block 22 constructed of a header part 22 and a data part 22, a block 2M constructed of a header part 2M and a data part 2M as shown in FIG. 4B. The data parts 21, 22, . . . , 2M correspond to each of the image data 21, 22, . . . , 2M of FIG. 4A.

Further, the cases of page 3 and page 4 are identical. These data structures are identically arranged at the lower portion of the data structure of page 2 of FIG. 4B and the data structures of image data of page 3 and page 4 only differ in that blocks in (n=1˜M) are replaced with blocks 3n (n=1˜M) and blocks 2n (n=1˜M) are replaced with blocks 4n (n=1˜M). In addition, in N-in-one printing in the first embodiment, when there are N pages of M blocks, M by N blocks are arranged and the blocks construct an N-in-one data structure and data setting space (configuration space) of N blocks is constructed. Both of reading and printing are made in units of M blocks. However, there is not always need to divide each page into plural blocks thus and the block unit can also be changed in a page unit. That is, one page may be set at one block and N pages may be M (=N) blocks. This will be described in a second embodiment.

Now, a detailed configuration of each block of a data structure will be described.

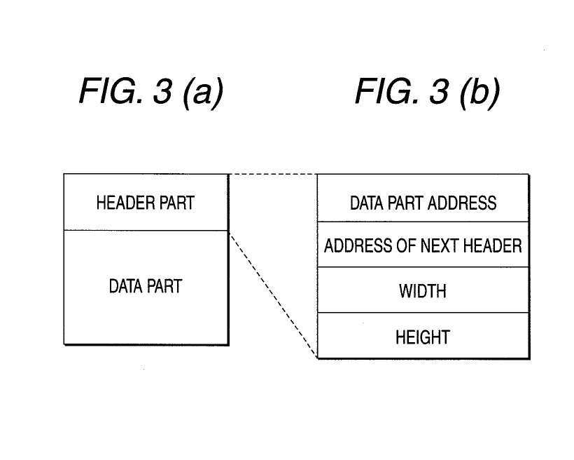

FIG. 3 is a block configuration diagram of the output processing apparatus in the first embodiment of the invention. Each block has a configuration as shown in FIGS. 3A and 3B, and the head region forms a header part (first region of the invention) and divided image data is stored in the other region (second region of the invention). FIG. 3B further shows a detailed configuration of this header part and is herein configured to dispose the following first to fourth fields. A head address of the divided image data stored in this block is stored in the first field shown in FIG. 3B, and a head address of a header part of a block to be next read out is stored in the second field. Also, a data width of one line of its divided image data is written in the third field, and a data height representing the total number of lines of the divided image data is written in the fourth field.

Consequently, the printing output controller 20 for controlling the printing output processing part 10 can store a head address of the first field acquired by the first transaction with respect to a data structure in a first address pointer 21a (described below) of a set register 21 in order to read out the divided image data. Also, based on a head address of a header part of the next block (block of page 2) stored in this second field, the printing output controller 20 performs readout with respect to the second data structure and reads out a head address of divided image data of the block written in the first field of the next block. Then, this can be stored in a second address pointer 21b of the set register 21.

Similarly, a data width of a third field and a data height of a fourth field obtained by the first readout can be respectively stored in a first data width register 21c and a first data height register 21e, and a data width of a third field and a data height of a fourth field obtained by the second readout can be respectively stored in a second data width register 21d and a second data height register 21f (see FIG. 7 for the first address pointer 21a, the second address pointer 21b, the first data width register 21c, the second data width register 21d, the first data height register 21e and the second data height register 21f).

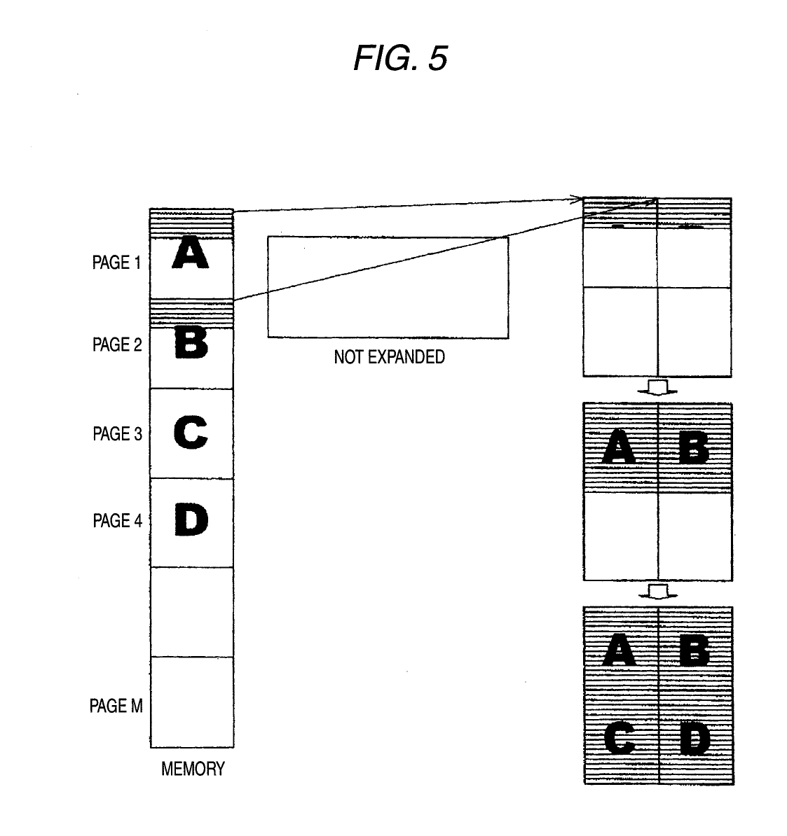

Therefore, in the case of printing the first line of page 1 of four-in-one, a head address of the first address pointer 21a is read out and based on this head address, image data forming the first line of page 1 could be read out. Next, a head address of the second address pointer 21b is read out and based on this head address, image data forming the first line of page 2 can be read out. In addition, when it is necessary to rotate an image (for example, the case of two-in-one or eight-in-one), data is read out of the RAM 7 by skipping at a predetermined skip width. The data read out thus can be reconfigured as one line of four-in-one by the printing output processing part 10. Here, FIG. 5 is an explanatory diagram conceptually showing a method of processing at the time of doing four-in-one printing of the output processing apparatus in the first embodiment of the invention. It is apparent from FIG. 5 that N pages of image data stored in the RAM 7 are not expanded in a buffer and are transmitted to the printing output processing part 10 in a line unit and are reconfigured as one line continuously.

Next, in order to output the second line, image data forming the second line of page 1 is read out and image data forming the second line of page 2 is read out. Thereafter, data of each line of page 1 and page 2 is alternately read out until data heights (the total number of lines) of the first data height register 21e and the second data height register 21f are reached by repeating an operation similar to that of the first line described above. A procedure of this readout is conceptually shown in FIG. 4A. In addition, FIG. 4A shows the case of four-in-one.

The above is a procedure for reading out the divided image data of page 1 and page 2, and when page 1 and page 2 are ended, page 3 and page 4 are read out in four-in-one printing. Its readout procedure is identically performed by replacing page 1 of FIG. 4A with page 3 and replacing page 2 with page 4. Consequently, four-in-one printing in which page 1 to page 4 are laid out in one page is ended. In the case of N-in-one (N=4 or more), an N-in-one layout is formed by repeating this procedure by N pages rather than four pages. In short, each block constructing the same column of plural pages is sequentially read out on a line-by-line basis and this is repeated and data of one line of each page is connected every the same column.

In addition, in the case of two-in-one, a layout in which an image is rotated 90° and two pages of size scaled down in a landscape direction are arranged vertically in two columns on a portrait page as shown in FIG. 6A could be formed, and also in the case of eight-in-one, a layout in which two pages scaled down in a landscape direction are used as one column and this column is arranged vertically in four columns on a portrait page as shown in FIG. 6C could be formed.

Here, referring further concretely to transmission of the image data described above, the printing output controller 20 transmits a transmission request so that data of the number of bits stored in the first data width register 21d is read out of an address set in the first address register 21a to the RAM 7 by a DMA address controller 23. When it is necessary to change (rotate) a direction of an image at this time, it is specified which address data corresponding to the rotated image data is read out and a transmission request is made. Consequently, an interface of the RAM 7 transmits the divided image data of the inside of a block 11 read out to the printing output processing part 10 which is a transmission destination.

Also, when this transmission is ended, in a manner similar to this, the printing output controller 20 makes a transmission request to the printing output processing part 10 so that data of the number of bits stored in the second data width register 21f is read out of an address set in the second address pointer 21b by the DMA address controller 23, and the RAM 7 transmits data read out to the printing output processing part 10 which is a transmission destination in a manner similar to the first transmission. In addition, this address is sequentially switched and requested by the DMA address controller 23.

Subsequently, a similar procedure is repeated and as shown in FIG. 4A, by the DMA address controller 23, a transmission source is switched from a data part 21 of page 2 to a data part 12 of page 1 and the transmission source is further switched from the data part 12 of page 1 to a data part 22 of page 2 and after this repeat, an address is finally switched from a data part 1N of page 1 to a data part 2N of page 2 and the transmission is ended.

Now, a configuration for performing data processing as shown in FIG. 5 in the printing output processing part 10 will be concretely described by returning again to FIG. 2 and further with reference to FIG. 7.

FIG. 7 is a block configuration diagram of the printing output processing part of the output processing apparatus in the first embodiment of the invention. In FIG. 7, numeral 20 is the printing output controller (controller of the invention) for controlling the printing output processing part 10 as described already, and numeral 20a is a counter. In the counter 20a, the number of transactions or the number of lines is counted. That is, when one line of data transmission is ended, the counter 20a is incremented. When a value of the counter 20a matches with the number of common lines of the first data height register 21e and the second data height register 21f, transmission of divided image data of this block is ended.

In FIG. 7, numeral 21 is a set register disposed in the printing output processing part 10. This comprises plural registers as described above. Numeral 21a is a first address pointer, and numeral 21b is a second address pointer, and numeral 21c is a first data width register for storing one line of data width transmitted first, and numeral 21d is a second data width register for storing one line of data width transmitted next, and numeral 21e is further a first data height register for storing the total number of lines of a block transmitted first, and numeral 21f is a second data height register for storing the total number of lines of a block transmitted next. Further, numeral 21g is a printing set register for setting instructions for an N-in-one layout inputted from an operation panel. In addition to this, a register (not shown) for setting a size of record paper is also disposed.

In addition, a flag register (not shown) for specifying whether a layout for laying out four-in-one is laid out in order of the top right, the top left, the bottom right and the bottom left, or in order of the top left, the top right, the bottom left and the bottom right, and also a flag register (not shown) for specifying whether a layout is laid out in order of the top right column, the top left column, the second right column, the second left column, the third right column, the third left column, the bottom right column and the bottom left column, or in order of the top left column, the top right column, the second left column, the second right column, the third left column, the third right column, the bottom left column and the bottom right column in the case of an eight-in-one layout could be disposed. This can be set by giving instructions for a layout of printing from an operation panel. The layout is laid out in certain order when it is not disposed. When this flag is set, control data for making a printing position adjustment is outputted to an output line buffer 27 by the printing output controller 20.

Further, in FIGS. 2 and 7, numeral 22 is a bridge for making connection between an internal bus 8 capable of 64-bit transmission and a local bus to which the printing device part 11 is connected. Also, numeral 23 shows the DMA address controller (DMA controller of the invention) described already, and when the printing output controller 20 requests transmission of image data from the RAM 7, an address resulting in a transmission source of its data is sequentially switched between an address of the first address register 21a and an address of the second address pointer 21b and is requested. In addition, transmission of the first embodiment is performed by DMA transmission of a 64-bit unit. Also, in the DMA address controller 23, an address is converted and transmission is requested when it is necessary to change a direction of an image.

Numeral 24 is a data buffer for sequentially storing transmitted data, and numerals 25, 26 are RAMs in which data stored in the data buffer 24 is respectively read out in order of a data width of the first data width register 21c and a data width of the second data width register 21d and is written. Therefore, when transmission sources are a block 11 of page 1 and a block 21 of page 2, data from the first line of the block 11 transmitted by DMA to the nth line of the first data height register 21e are continuously written and similarly, data from the first line of the block 21 transmitted by DMA to the nth line of the second data height register 21e are continuously written.

The data of the RAMs 25, 26 are respectively outputted to the output line buffer 27 on a one line of data basis by the printing output controller 20. First, data corresponding to the first line of the block 11 of page 1 stored in the RAM 25 is outputted to the output line buffer 27 and subsequently, data corresponding to the first line of the block 21 of page 2 stored in the RAM 26 is outputted to the output line buffer 27. When a printing position adjustment of layout order etc. is required, it is outputted in this order.

When the first line of N-in-one in which each of one line of scaled-down data of page 1 and page 2 is connected is outputted from the RAMs 25, 26, the second line of N-in-one is outputted using data of the second line stored in the RAMs 25, 26. Further, by repeating this to a data part 1M and a data part 2M, an image in which page 1 and page 2 of N-in-one are laid out can be obtained. FIG. 4 shows formation of this image. In the case of four-in-one, page 1 to page 4 are laid out as shown in FIG. 4.

Subsequently, in FIGS. 2 and 7, numeral 28 is a print data output part for outputting image data imaged and formed by the output line buffer 27, and numeral 29 is a clock generation part for doing a clock input of video data signal generation to the print data output part 28, and numeral 30 is a laser control part for oscillating laser light for forming an image based on a video data signal outputted from the print data output part 28. The clock generation part 29 counts a predetermined printing output start margin (ETM of a margin from the top end) from a printing output head reference signal (NTOP) for a head line, and further counts a predetermined printing output start margin (ELM which is a margin from the left end) from a printing output reference signal (NHSYNC) of each line, and does a clock input for video data signal generation.

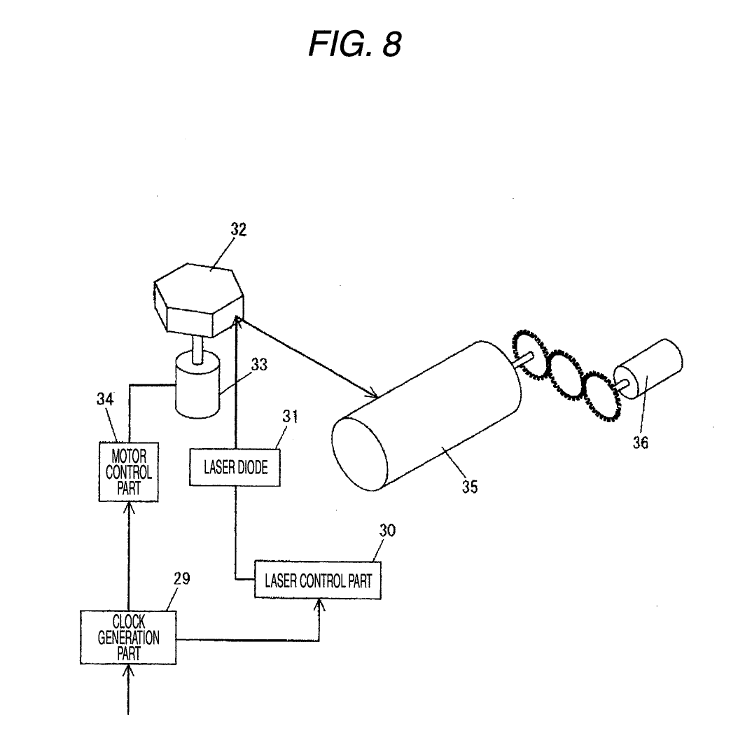

FIG. 8 is a main explanatory diagram for image formation of the printing device part. In FIG. 8, numeral 31 is a laser diode for oscillating laser light controlled based on a video data signal by the laser control part 30, and numeral 32 is a polygon mirror for scanning the laser light oscillated by the laser diode 31. This polygon mirror 32 is rotated in synchronization with a scanning speed of one line. Numeral 33 is a motor for rotating the polygon mirror 32, and numeral 34 is a motor control part for controlling rotation of the motor 33. The printing output reference signal is generated in synchronization with this scan.

Also, numeral 35 is a photoconductor drum in which a photoconductive layer such as an organic photoconductor (OPC) is formed on a surface and rotates and an electrostatic latent image is formed and is visualized and imaged by toner. The photoconductor drum 35 is uniformly electrified by an electrification device (not shown) and an electrostatic latent image is formed on the surface by laser light from the polygon mirror 32. A toner image formed on the photoconductor drum 35 is transferred to record paper by a transfer device (not shown). Thereafter, the image is fixed by a fixing device and the paper is delivered. Numeral 36 is a motor for driving the photoconductor drum 35. The motor 36 is driven in synchronization with the motor 33. It can also be driven using one motor. The printing output head reference signal described above is generated at timing of transfer.

In addition, the printing output controller 20 controls a clock outputted from the clock generation part 29 by a printing output start margin counted by a counter (not shown) and synchronizes timing of the polygon mirror 32 with timing of emission of laser light. Also, a register (not shown) for setting the margin is disposed in the set register 21.

Therefore, the functions of the output processing apparatus in the digital composite machine 1 explained above will be described by a sequence chart.

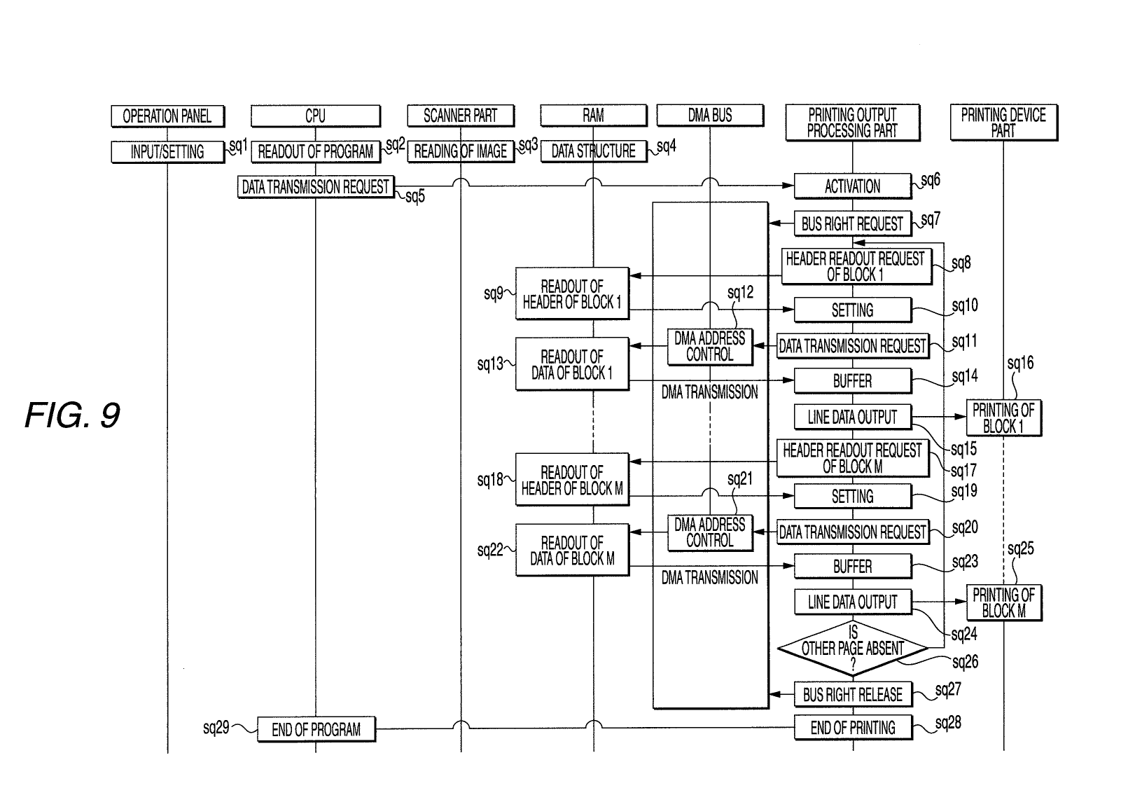

FIG. 9 shows a sequence chart of the output processing apparatus in the first embodiment of the invention. As shown in FIG. 9, an instruction to the effect that a copy is made, an N-in-one instruction, etc. are given from an operation panel (sq1) and when a start button of the operation panel is pushed, a program for executing a copy function is read out of ROM to the CPU 5 (sq2) and the scanner part 2 starts image reading of a manuscript (sq3) and a data structure constructed of plural blocks made of a header and image data according to N-in-one setting is generated in the RAM 7 (sq4).

Thereafter, the CPU 5 requests data transmission from the printing output controller 20 (sq5). Consequently, the printing output controller 20 is activated (sq6) and the printing output controller 20 requests a bus right from the internal bus 8 for DMA transmission (sq7) and requests readout of a header part included in each block 1 of pages 1 and 2 from the RAM 7 (sq8). On the other hand, the RAM 7 reads out the header part of each block 1 (sq9) and the printing output controller 20 acquiring this makes various settings in each register of the set register 21 (sq10) and reserves at least one line of memory inside the output line buffer 27.

Then, the printing output controller 20 requests transmission of image data of a data part disposed in each block 1 of pages 1 and 2 from the RAM 7 (sq11). DMA address control is performed by the DMA address controller 23b and transmission is requested (sq12) and the RAM 7 alternately reads out image data included in each block 1 of pages 1 and 2 in a form corresponding to N-in-one (sq13) and the image data read out is alternately transmitted in a line unit. By this transmission, the image data of the block 1 is stored in the data buffer 24 of the printing output processing part 10 one after another (sq14).

Thereafter, in the output line buffer 27, each one line of pages 1 and 2 is sequentially fetched and is continuously arranged to construct one line and this is repeated and image data of the block 1 results in data laid out in an N-in-one format in pages 1 and 2 and is outputted from the print data output part 28 to the printing device part 11 (sq15). In addition, when one line is constructed, the data is outputted from the print data output part 28 to the printing device part 11 in a line unit and printing of blocks 1 of pages 1 and 2 is done (sq16).

After the block 1, this procedure is repeated to block 2, . . . , block M. Also in the block M, the printing output controller 20 makes a request so as to read out a header part of each block M of pages 1 and 2 (sq17) and reads out the header part of the block M (sq18) and sets each register (sq19) and reserves at least one line of memory and makes a request so as to transmit image data of a data part 1M and a data part 2M of each block M (sq20) and performs DMA address control (sq21) and reads out image data included in each block M (sq22) and transmits the image data. This is stored in the data buffer 24 (sq23) and thereafter, in the output line buffer 27, each one line of pages 1 and 2 is sequentially fetched and is continuously arranged and this is repeated and image data of the block M is laid out in an N-in-one format and is outputted from the print data output part 28 to the printing device part 11 (sq24) in a line unit and printing of each block M is done (sq25).

In the case of reaching the block M, the counter 20a counts n=M and the printing output controller 20 decides that a layout of pages 1 and 2 is ended, and determines whether or not there is a layout of page 3, page 4 or other pages (sq26). When there is a further layout, readout and output are repeated and when there is no layout, the bus right is released (sq27) and data processing by transmission is ended (sq28) and the CPU 5 ends execution of the copy function (sq29).

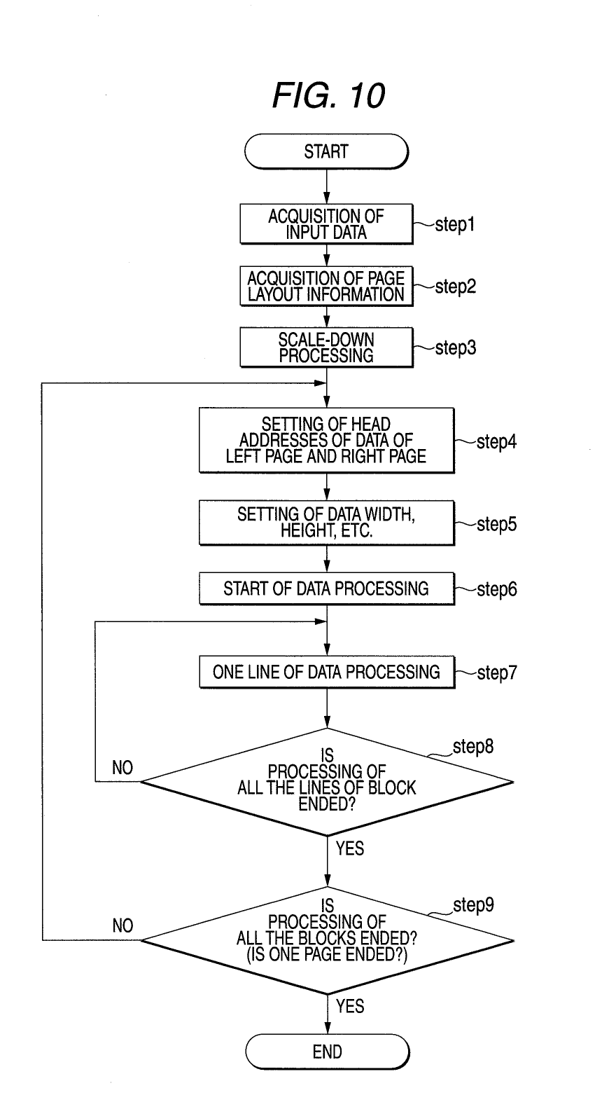

Subsequently, a procedure for performing output processing for a layout of N-in-one printing by the digital composite machine 1 of the first embodiment will be described based on flowcharts of FIGS. 10, 11 and 12.

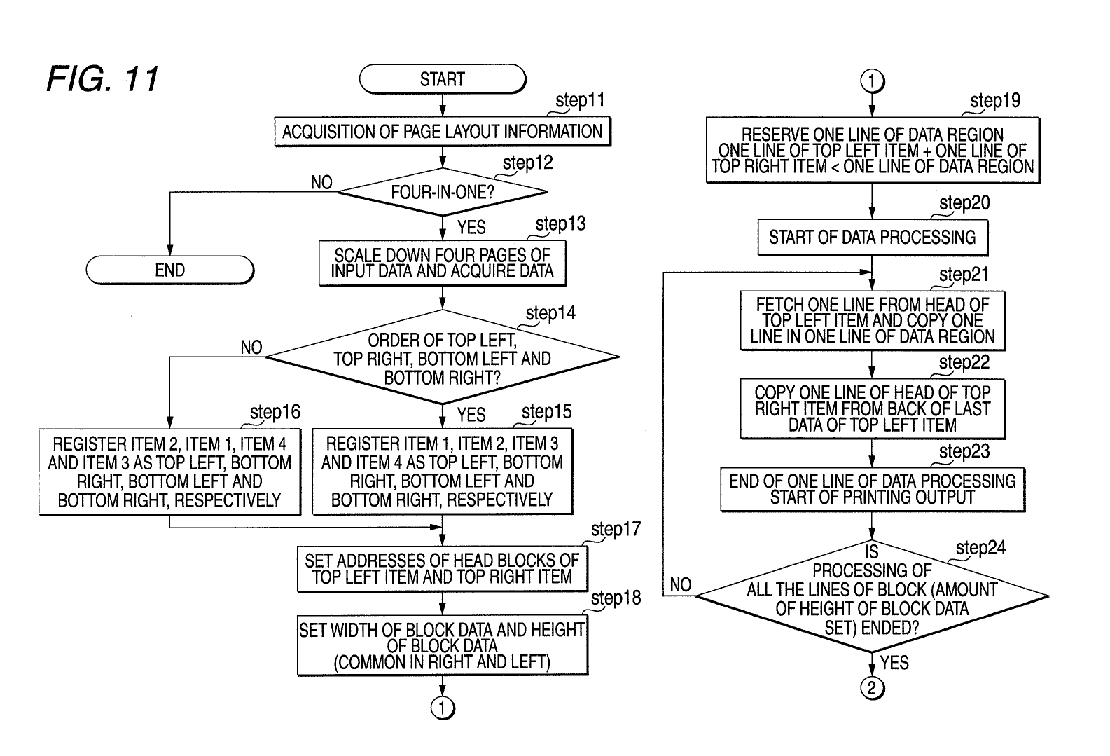

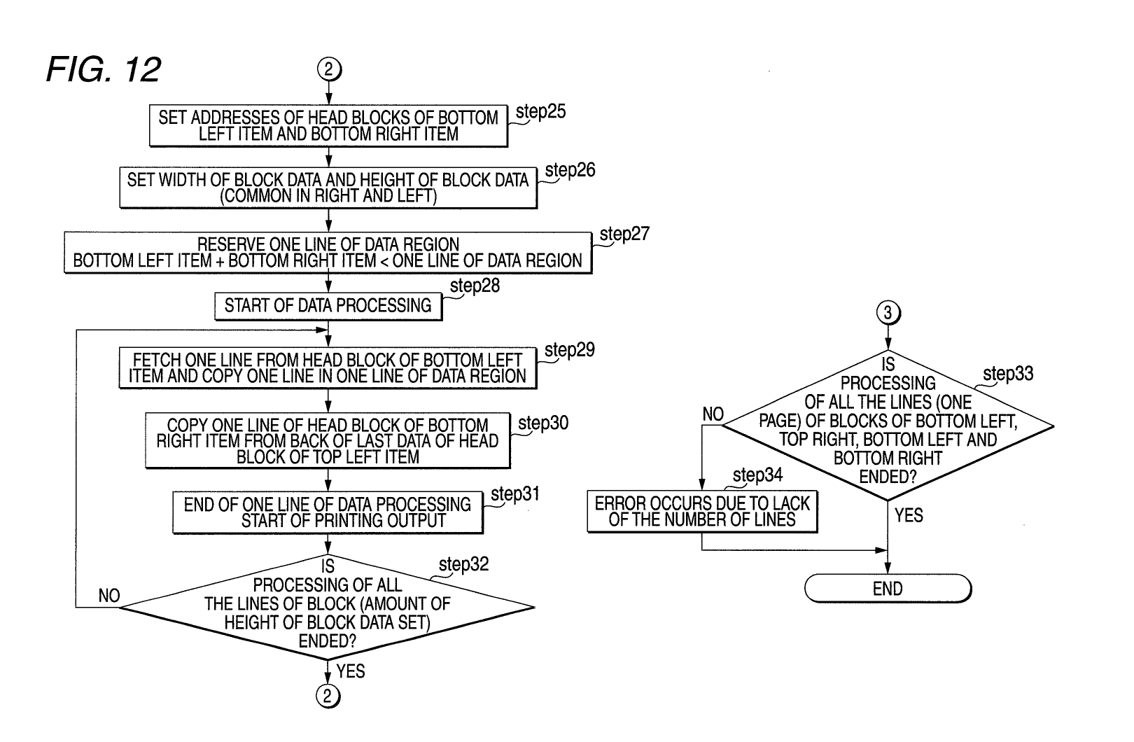

FIG. 10 is a flowchart of the case of performing a two-in-one layout, and FIG. 11 is a flowchart of the case of laying out the top column in the case of performing a four-in-one layout, and FIG. 12 is a flowchart of the case of laying out the bottom column in the case of performing a four-in-one layout.

Here, a procedure of data processing for two-in-one printing will be first described. When the image processing part 9 acquires read data from the scanner part 2 (step 1), page layout information is acquired with reference to the printing set register 21g (step 2). In addition, as input data, data stored in a memory card, print data from a host computer, image data of a fax machine, etc. are similar in addition to the read data from the scanner part 2. These data are stored in a data part of a data structure made of a block comprising a header part and the data part. The number of blocks may be any of one to M blocks. Scale-down processing is performed when page layout information for performing a two-in-one layout is set (step 3).

Next, from header parts respectively corresponding to page 1 (left page) and page 2 (right page), head addresses of respective image data are set in the first and second address pointers 21a, 21b (step 4). Also, respective data widths and data heights are set in the first and second data width registers 21c, 21d and the first and second data height registers 21e, 21f (step 5). After this, data processing is started (step 6). The data processing is performed with respect to the data read out so as to change a direction of an image.

One line of data processing in a common block of page 1 (left page) and page 2 (right page) is performed (step 7) and these are laid out as one line in the same block and it is decided whether or not processing of all the lines of the inside of this block is ended (step 8). When the data processing of all the lines of the inside of the block is not ended, the flowchart returns to step 7 and when the processing is ended, it is decided whether or not processing of all the blocks of page 1 (left page) and page 2 (right page) is ended (step 9).

When the data processing of all the lines of the inside of all the blocks is not ended in step 9, the flowchart returns to step 4 in order to again perform the processing and when the processing is ended, the printing output processing is ended since the two-in-one layout in one page is ended.

Next, a procedure of data processing for four-in-one printing will be described. When read data is acquired from the scanner part 2, page layout information is acquired with reference to the printing set register 21h (step 11). Then, it is determined whether or not a four-in-one layout is performed (step 12), and when the four-in-one layout is not performed, the processing is ended as it is and in the case of four-in-one, scale-down processing of four pages of input data is performed (step 13).

Then, it is decided whether or not to be laid out in order of the top left, the top right, the bottom left and the bottom right as a layout (output format) of each page (step 14). When setting to that effect is made from an operation panel, a flag representing this is set and page 1, page 2, page 3 and page 4 are registered as the top left, the top right, the bottom left and the bottom right, respectively (step 15). When it is not laid out in order of the top left, the top right, the bottom left and the bottom right in step 14, page 1, page 2, page 3 and page 4 are registered as the top right, the top left, the bottom right and the bottom left, respectively (step 16).

After this, from each of the header parts corresponding to head blocks of the top left page and the top right page, head addresses of respective image data are set in the first and second address pointers 21a, 21b (step 17). Also, respective data widths and data heights are set in the first and second data width registers 21c, 21d and the first and second data height registers 21e, 21f (step 18). In addition, the data widths and data heights are common in the right and left pages.

Subsequently, a data region of one line of four-in-one is reserved inside the output line buffer 27, and a region to which a region of one line of the top left page and a region of one line of the top right page are added is constructed so as to become a region larger than a size of this data region (step 19). Data processing is started in this state (step 20).

The printing output controller 20 transmits data of one line of the right and left pages and stores image data of one line of the top left page in the RAM 25 and also stores image data of one line of the top right page in the RAM 26 and thereby, the data processing is performed and thereafter, image data of one line of the top left page is fetched from the RAM 25 and is copied in the data region of one line inside the output line buffer 27 (step 21) and further, image data of one line of the top right page is fetched from the RAM 26 and is continuously copied in the back of the last data of the top left page (step 22). In addition, when there is a printing position adjustment of layout order, the right and left are outputted in reverse. Consequently, one line of data processing is ended and a printing output is started from the print data output part 28 to the printing device part 11 (step 23).

After this, it is decided whether or not processing of all the lines of the block is ended (step 24), and when the number of lines counted by the counter 20a does not reach the data heights set in the first and second data height registers 21e, 21f, the flowchart returns to step 21 and the processing is continued and when the number of lines reaches the data heights, processing of the bottom left page and the bottom right page is performed.

The processing of the bottom left page and the bottom right page will be described based on the flowchart of the case of laying out the bottom column of FIG. 12. From each of the header parts corresponding to head blocks of the bottom left page and the bottom right page, head addresses of respective image data are set in the first and second address pointers 21a, 21b (step 25). Also, respective data widths and data heights are set in the first and second data width registers 21c, 21d and the first and second data height registers 21e, 21f (step 26). In addition, the data widths and data heights are common in the right and left pages.

Subsequently, a data region of one line is reserved inside the output line buffer 27, and a region to which a region of one line of the bottom left page and a region of one line of the bottom right page are added is constructed so as to become a region larger than a size of this data region (step 27). Data processing is started in this state (step 28). The printing output controller 20 transmits data of one block of the right and left pages and stores image data of one block of the bottom left page in the RAM 25 and also stores image data of one block of the bottom right page in the RAM 26 and thereby, the data processing is performed.

Thereafter, image data of one line of the bottom left page is fetched from the RAM 25 and is copied in the data region of one line inside the output line buffer 27 (step 29) and further, image data of one line of the bottom right page is fetched from the RAM 26 and is continuously copied in the back of the last data of the bottom left page (step 30). When there is a printing position adjustment of layout order, the right and left are outputted in reverse. Consequently, one line of data processing is ended and a printing output is started from the print data output part 28 to the printing device part 11 (step 31). After this, it is decided whether or not processing of all the lines of the block is ended (step 32), and when the number of lines counted by the counter 20a does not reach the data heights set in the first and second data height registers 21e, 21f, the flowchart returns to step 29 and the processing is continued and when the number of lines reaches the data heights, the output format is checked.

It is checked whether or not all the lines of all the blocks are processed in the output format set in step 14, that is, for example, in layout order of the top left, the top right, the bottom left and the bottom right (step 33), and when they are not processed, it is decided that an error occurs due to lack of the number of lines (step 34), and when they are processed, the printing output processing is normally ended.

Thus, the output processing apparatus of the digital composite machine in the first embodiment of the invention can do N-in-one printing at high speed without expanding data of N pages in memory, and it is unnecessary to separately dispose memory for rearranging image data according to an N-in-one format, and images of N pages can be printed by a simple configuration. Further, image data acquired without the intervention of the memory for rearranging image data is directly outputted to the printing device part, so that time taken to perform data processing in the case of image processing can be reduced.

Also, while deciding the amount of output of image data by a data width of each image data inputted in a block unit, the same line of plural continuous image data is sequentially read out of a data part, so that the same image data as data acquired by expanding N pages of image data in memory once can be outputted by only using the output line buffer, and plural images can be printed on one sheet of record paper according to a size of N of an N-in-one recording function instructed while reducing time taken to perform data processing.

### Second Embodiment

An output processing apparatus in a second embodiment of the invention will be described below based on the drawings.

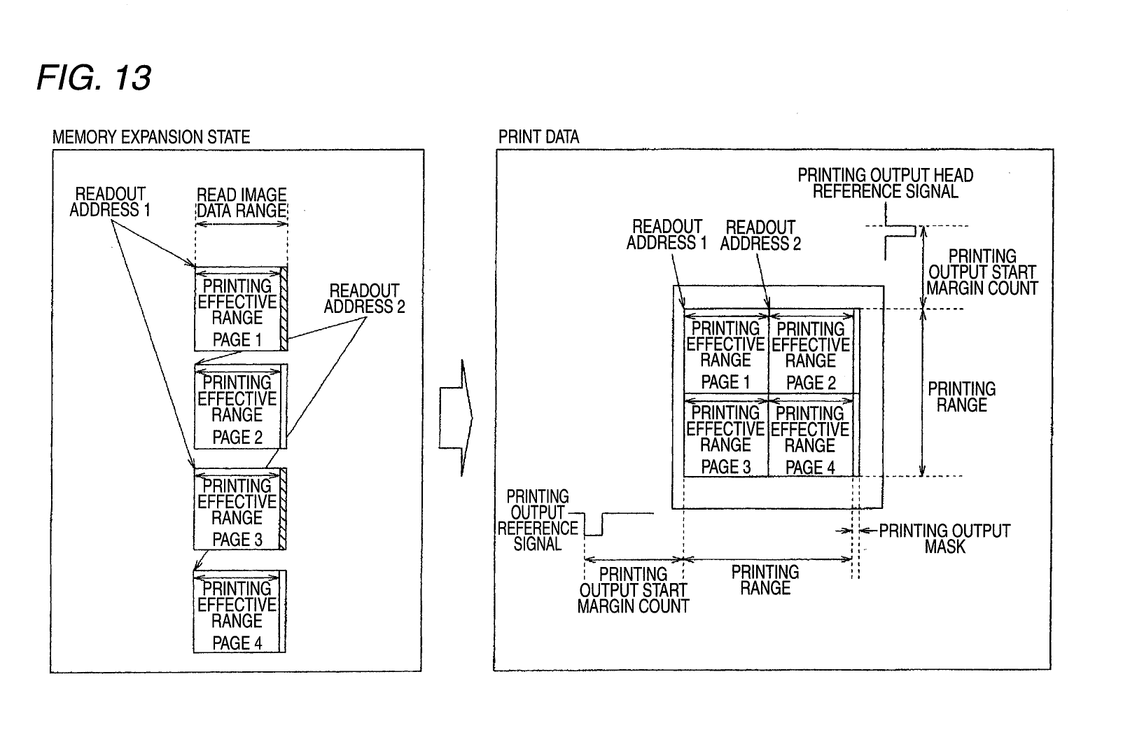

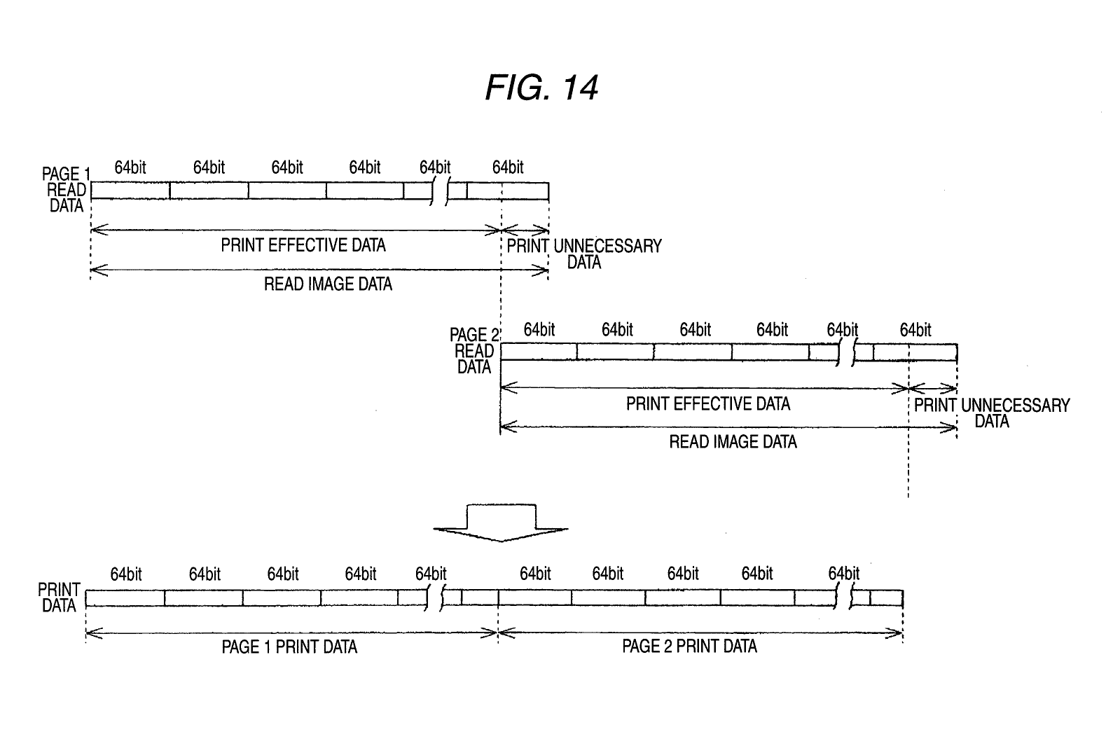

FIG. 13 is a diagram of relation between print data and a memory configuration at the time of printing data read by the output processing apparatus in the second embodiment of the invention, and FIG. 14 is a diagram of relation between print data and read data of the output processing apparatus in the second embodiment of the invention. Since the second embodiment is basically common to the first embodiment in a configuration of the output processing apparatus of the digital composite machine, FIGS. 1 to 12 are seen also in description of the second embodiment. Since a configuration of the same numeral as the first embodiment shows the same configuration also in the second embodiment unless otherwise described, the description herein is omitted.

In the output processing apparatus of the second embodiment, rather than dividing one page into plural blocks and storing image data as described in the first embodiment, this image data is stored in a page unit and also a throughput for N-in-one printing is made lower than the case of the first embodiment.

FIG. 13 shows a relation between print data and a memory configuration in the second embodiment at the time of printing data in a format of four-in-one printing expanded on the RAM 7 read. In a manner similar to the first embodiment, in the second embodiment, one line is respectively readout of a readout address 1 of the head of image data of page 1 and a readout address 2 of the head of image data of page 2, and one line of the case of four-in-one is constructed of both the lines of pages 1 and 2. When a layout of pages 1 and 2 is ended, one line is respectively read out of a readout address 1 of the head of image data of page 3 and a readout address 2 of the head of image data of page 4, and one line is constructed of both the lines of pages 3 and 4 and is printed. Therefore, the second embodiment corresponds to the case where the number of blocks is set at M=1 in the description of the first embodiment. Configurations of a data part and a header part are similar to those of FIGS. 3A and 3B. As a result of this, these descriptions are handed over to the first embodiment and are omitted.

Now, as shown in the left diagram of FIG. 13, a printing effective range necessary for printing is slightly narrower than an image data range read by the scanner part 2, and print unnecessary data is included in the last 64-bit data constructing one line. In the top column of FIG. 14, a situation in which read image data of page 1 is transmitted by DMA through the internal bus 8 in a 64-bit unit (32 bit times 2) and print unnecessary data is present in the last 64-bit data is shown, and a situation in which print unnecessary data is present in the last 64-bit data similarly in read image data of page 2 is shown.

Therefore, the substantial read image data of page 1 and page 2 are outputted in a line unit through the print unnecessary data of the bottom of page 1. However, this print unnecessary data is data padded by a difference between read data and print (transmission) data in the amount of data, and is not meaningful for an image. When this print unnecessary data is processed and outputted in a manner similar to other effective image data, the processing to these unnecessary data is wasted and also time taken to perform data processing increases.

Hence, in the second embodiment, when read image data stored in the RAM 25 is outputted to the output line buffer 27, as shown in the bottom column of FIG. 14, by the printing output controller 20, the read image data is outputted at the line bottom of page 1 and page 3 (page to the front of the last page of the same column of plural pages including plural pages other than the right page in two pages of the right and left) excluding the print unnecessary data and thereafter, the read image data is similarly outputted at the line bottom of page 2 and page 4 (the last page of the same column) and the data are connected in the absence of the print unnecessary data to construct one line.

A fill width of this excluded print unnecessary data is preset in the set register 21. In addition, the printing output controller 20 does not produce an output excluding the print unnecessary data on the left page, and read image data of the left page is outputted to the output line buffer 27 as it is and by the printing output controller 20, control may be performed so as to overwrite data of the right page by the fill width of the print unnecessary data of the bottom and one line of N-in-one may be constructed.

Consequently, print data printed by the printing device part 11 is shown in the right diagram of FIG. 13, and is printed as a compact image without including the print unnecessary data between the left pages (pages 1, 2) and the right pages (pages 3, 4). According to this configuration, data is outputted to a recording device as one line of continuous image data in a state of excluding a recording unnecessary region, so that the image data can be stored in the output line buffer 27 at high speed on a recording output request and a capacity of the output line buffer 27 can be reduced and the same image data as data acquired by expanding plural pages of image data in memory once can be outputted by only using the output line buffer 27.

Further, an output may be produced after a mask for printing output is performed in the print unnecessary data of the bottom of pages 2, 4 (the last page of the same column). For this purpose, the printing output controller 20 fills a fill width of the print unnecessary data included in the bottom of pages 2, 4 with zero (space) and deletes data of the fill width. By this configuration, an unnecessary region is eliminated and processing is also facilitated and a speedup is achieved.

In the case of printing, predetermined printing output start margins (ELM which is a margin from the left end and ETM of a margin from the top end) are counted from a printing output reference signal (NHSYNC) and a printing output head reference signal (NTOP) every line, and a clock input for video data signal generation is done to the laser control part 30. Consequently, a four-in-one image is compactly printed as a whole while four pages are laid out with the pages moved to the left side as a whole and the predetermined margins are ensured.

Thus, the output processing apparatus of the digital composite machine in the second embodiment of the invention reads out the same line of image data of plural continuous pages and produces an output to the printing device part as one line of continuous image data without outputting a printing unnecessary region generated at the bottom of one line of the image data read out and thereby, the image data can be outputted to the output line buffer stably at high speed on a printing output request and the output line buffer can be effectively used.

The present application is based on Japanese Patent Application (No. 2006-307452) filed on Nov. 14, 2006, the contents of which are incorporated herein by reference.

What is claimed is:

1. An output processing apparatus comprising:
a first storage that stores image data in a predetermined block unit,
a second storage that stores a head address of each of the image data stored in the block units, and
a controller that reads, from the first storage, the same line of the image data of the plural continuous blocks on a line-by-line basis based on the head address stored in the second storage, and outputs the plural lines of the readout image data to a recorder as one line of continuous image data, the recorder recording the image data.

2. The output processing apparatus according to claim 1, wherein the predetermined block unit comprises a page unit.

3. The output processing apparatus according to claim 1 further comprising an instruction unit that gives instructions for an N-in-one recording function of recording plural image data on one record medium by arranging plural image data in the same column of one record medium and disposing the column by a predetermined number,
wherein the second storage stores length information about each of the image data and the head address of each of the image data stored in the block unit,
wherein the controller decides that an output of images of the plural blocks inside the same column is completed when image data of the amount satisfying the length information about each of the image data stored in the second storage is outputted to the recorder based on instructions for the N-in-one recording function.

4. The output processing apparatus according to claim 3, wherein the controller reads the same line of plural next continuous blocks on a line-by-line basis from the first storage and outputs the line to the next column when the number of columns constructed by image data outputted to the recorder is less than the predetermined number.

5. The output processing apparatus according to claim 3,
wherein the controller reads the same line of plural blocks corresponding to the next page on a line-by-line basis from the first storage when the number of columns constructed by image data outputted to the recorder is less than the predetermined number.

6. The output processing apparatus according to claim 3,
wherein the control decides that an output of image data of one sheet of the record medium is completed when the number of columns constructed by image data outputted to the recorder reaches the predetermined number.

7. The output processing apparatus according to claim 1, further comprising a third storage that stores one line of the continuous image data, wherein the controller temporarily stores one line of the continuous image data in the third storage before one line of the continuous image data is outputted to the recorder.

8. The output processing apparatus according to claim 2, wherein the predetermined block unit is constructed of a page unit of the inputted image data.

9. The output processing apparatus according to claim 1, wherein the image data is image data acquired by a reader.

10. The output processing apparatus according to claim 1, wherein the image data is image data stored in a memory card.

11. The output processing apparatus according to claim 7 further comprising a DMA controller for forming a readout address and transmitting the address to the recorder when data of the same line of plural pages is read from the first storage,
wherein the DMA controller transmits data of the same line of the plural pages to the recorder as one line of image data based on the head address, and the controller stores the transmitted image data in the third storage.

12. The output processing apparatus according to claim 11, wherein in the case of reading out, as one line, the same line of image data in which image data of plural pages is rotated when data of the same line of plural pages is read from the first storage, the DMA controller requests the first storage to continuously transmit image data using an address corresponding to the rotated image data.

13. The output processing apparatus according to claim 7, wherein a recording unnecessary region is set at an end of one line of image data, the recording unnecessary region being distinct from an effective recording range in the one line, and
Wherein, when the controller stores in the third storage data of the same line of the plural pages as one line of image data, the recording unnecessary region is excluded from each line of a page previously written in the third storage and image data of each line of the next page is written in the third storage.

14. A output processing method of image data, the method comprising:
storing in a first storage the image data in a predetermined block;
storing in a second storage a head address of each of the image data stored in the block unit;
reading out from the first storage the same line of the image data of the plural continuous blocks on a line-by-line basis based on the head address stored in the second storage; and
outputting plural lines of the readout image data to a recorder as one line of continuous image data, the recorder recording the image data.
